(19) United States
(12) Patent Application Publication
(10) Pub. No.: US 2019/0343146 A1
(43) Pub. Date: Nov. 14, 2019

(54) PET FOOD PRODUCT

(71) Applicant: MARS, INCORPORATED, McLean, VA (US)

(72) Inventors: Seronei Chelulei Cheison, Verden (DE); Maik Michael Herrmann, Verden (DE); Holger X. SCHUMACHER, Verden (DE)

(73) Assignee: MARS, INCORPORATED, McLean, VA (US)

(21) Appl. No.: 16/473,713

(22) PCT Filed: Dec. 15, 2017
(86) PCT No.: PCT/US2017/066793

§ 371 Date: Jun. 26, 2019

(30) Foreign Application Priority Data
Dec. 29, 2016 (GB) 1622356.2

(51) Int. Cl. A23K 10/24; A23K 10/30; A23K 40/00

(52) U.S. Cl. CPC A23K 10/24; A23K 50/48; A23K 40/00; A23K 10/30

(57) ABSTRACT

Novel blends useful for use in manufacturing petfood products are disclosed. These novel blends can be used to manufacture petfood products which have physical integrity. They are also used to manufacture petfood products that are palatable to pets and with acceptable texture and/or smell to pet owners. The blends can be utilised using existing equipment and techniques. Also described are novel petfood products manufactured using the blends.

The invention relates to the use of pea product blends in pet food products, to the pet food products containing the pea product blends and processes for the preparation of the pet food products.

Pet foods have long been manufactured from animal by-products and non-animal derived ingredients in order to prepare high quality food that provide the pet with the required nutrient profile without competing with the human food demand for meat. As the global population increases the global demand for high protein foods including meat is expected to increase, so an increasing need for pet foods prepared from alternative proteins while meeting the nutritional needs of pets is expected. There is therefore an increasing need for pet foods to be manufactured from more sustainable proteins, in particular for pet foods incorporating a higher amount of non-animal protein while maintaining or improving high levels of nutrition and quality.

Replacing animal proteins with alternative proteins in pet foods requires a number of issues to be addressed, e.g. the products must have integrity (they must not dry out or crumble), they must be palatable to the pet and must have textures and smells that are desirable to both the pet and the pet owner. It is also preferable for new analogue products to be prepared and processed using existing processing assets, and using recipes which are otherwise the same as or similar to existing products.

Pet food is commonly categorized on the basis of its moisture content:

(1) Dry or low moisture content products (defined herein as exhibiting less than 15 wt % moisture content). These products typically combine high nutritional content with convenience.
(2) Semi-moist or semi-dry or soft dry or intermediate or medium moisture content products (defined herein as exhibiting from 15 to 50 wt % moisture content).
(3) Wet or high moisture content products (defined herein as exhibiting greater than 50 wt % moisture content). These products are generally most palatable to pets.

The present invention is particularly directed towards wet pet food, of which there are two main types.

The first type of wet pet food product is known as ‘pate’ or ‘loaf’ and is typically prepared by processing a mixture of edible components under heat to produce a homogeneous semi-solid mass that is structured by heat-coagulated protein. This homogeneous mass is usually packaged into single serve or multi serve packaging which is then sealed and sterilized. Upon packing, the homogeneous mass assumes the shape of the container.

The second type of wet pet food product is known as ‘chunk-in-gravy’, ‘chunk-in-jelly’ or ‘chunk-in-mousse’, depending on the nature of the sauce component, and these types of products are referred to generically herein as ‘chunk-in-sauce’ products. The present invention is particularly directed to ‘chunk-in-sauce’ wet pet food products. The chunks comprise meat pieces or restructured meat pieces. Restructured meat pieces are typically prepared by making a meat emulsion containing a heat-settable component, and by applying thermal energy to ‘set’ the emulsion and allowing it to assume the desired shape. The product pieces are combined with a sauce (e.g. gravy, jelly or mousse) in single serve or multi serve packaging which is then sealed and sterilized.

Many wet pet food products contain a significant amount of meat and animal by-products. Reconstitution of animal by-products into aesthetically pleasing restructured or reconstituted meat chunks is a key feature of most wet pet food products. A widely used technology relies on the heat setting of meat proteins and the addition of heat-settable binders. Soluble meat proteins coagulate and create a strong matrix when heated above 80° C. Additives such as dried animal blood plasma and other heat-setting binders are included to give sufficient chunk strength, particularly such that the matrix is able to withstand the retort/sterilisation process described hereinbelow. However, blood plasma is an expensive commodity, and it would be desirable to utilise other binders which have a more sustainable and/or flexible and/or economic supply.

It would be desirable to provide a replacement for animal blood plasma in reconstituted meat chunks and wet pet food products, particularly wherein the physical characteristics of the reconstituted meat chunks and wet pet food products are maintained or improved.

One physical characteristic of the reconstituted meat chunks which is of particular importance is chunk strength or hardness. A chunk which is too weak or too soft is more easily broken or fragmented, which undesirably reduces the stability and cohesiveness of the chunk. In addition, this can result in small pieces or “fines” (solid material with a longest dimension of no more than 3 mm) being present in the product, which is undesirable for a number of reasons. For instance, fines tend to migrate to the surface of the product and are visible to the consumer (i.e. the pet owner) upon opening of the packaged product, which generates an undesirable perception of a lack of freshness or quality.

A further consideration for replacement products is that they should desirably be processable using existing equipment. For instance, the reconstituted meat chunks should desirably not exhibit a tack or stickiness which would cause the chunks to stick to the conveyors used to transport the chunks during manufacture, thereby resulting in the need to clean and un-block the conveyors causing undesirable equipment down-time. Thus, any analogue product using replacement ingredients should not exhibit increased tack or stickiness, relative to existing products in which the heat-settable binder is animal blood plasma.

In addition, the pet food product must exhibit a texture and smell such that it is palatable to the pet, which is a particular problem when the pet food is a cat food, since cats are typically more selective than dogs. Thus, any analogue product using replacement ingredients should at least maintain the palatability of existing products in which the heat-settable binder is animal blood plasma.

It is an object of this invention to overcome one or more of the afore-mentioned problems.

According to a first aspect of the invention, there is provided a reconstituted animal material comprising animal protein and a binder, wherein said binder comprises: (i) animal blood plasma; (ii) a pea fibre component; and (iii) a pea protein component, wherein components (ii) and (iii) are different and are derived from pea vegetable matter, and wherein the binder comprises:
component (i) in an amount of from about 20 to about 65 wt %, by total weight of the binder;
component (ii) in an amount such that the binder comprises from about 10 wt % to about 25 wt % pea fibre, by total weight of the binder; and
component (iii) in an amount such that the binder comprises from about 2 wt % to about 15 wt % pea protein, by total weight of the binder.

According to a second aspect of the present invention, there is provided a pet food product, particularly a wet pet food product, comprising the reconstituted animal material of the first aspect of the invention.

According to a third aspect of the present invention, there is provided the use of a composition comprising: (i) animal blood plasma; (ii) a pea fibre component; and (iii) a pea protein component, as a binder in reconstituted animal material comprising animal protein, wherein components (ii) and (iii) are different and are derived from pea vegetable matter, and wherein said composition comprises:
component (i) in an amount of from about 20 to about 65 wt %, by total weight of the composition;
component (ii) in an amount such that the composition comprises from about 10 wt % to about 25 wt % pea fibre, by total weight of the composition; and
component (iii) in an amount such that the composition comprises from about 2 wt % to about 15 wt % pea protein, by total weight of the composition,

particularly wherein said reconstituted animal material is suitable for, or present in, a pet food product, particularly a wet pet food product.

Unexpectedly, the present inventors have found that said composition comprising: (i) animal blood plasma; (ii) a pea fibre component; and (iii) a pea protein component, can be used as a binder in reconstituted animal material, a pet food product, particularly a wet pet food product.

As used herein, the term “pea fibre component” refers to a product that contains pea fibre, but need not be entirely composed of pea fibre. Thus, a “pea fibre component” comprises, consists essentially of, or consists of, pea fiber. Preferably, the pea fibre component comprises at least about 45 wt %, preferably at least about 50 wt % pea fibre, by total weight of the pea fibre component. For example, one commercially available pea fibre is 20-100 μm pea fiber from DPS/Dutch Protein Services having a maximum of 66% dietary fibre (AOAC991.43 dry basis). In a preferred embodiment, the pea fibre component comprises from about 45 to about 60 wt %, preferably from about 45 to about 55 wt % pea fibre, by total weight of the pea fibre component. The pea fibre component may optionally comprise up to about 10 wt % pea protein, preferably from about 5 wt % to about 10 wt % pea protein. The balance of the pea fibre component typically further comprises starches and other carbohydrates, and moisture.

As used herein, the term “pea protein component” refers to a product that contains pea protein, but need not be entirely composed of pea protein. Thus, a “pea protein component” comprises, consists essentially of, or consists of, pea protein, and preferably comprises pea protein. Preferably, the pea protein component comprises at least about 20 wt %, preferably at least about 25 wt %, or at least about 30 wt %, or at least about 40 wt %, or at least about 50 wt %, or at least about 60 wt %, or at least about 70 wt %, or at least about 75 wt % pea protein, by total weight of the pea protein component. In a preferred embodiment, the pea protein component comprises from about 25 to about 60 wt %, preferably from about 25 to about 55 wt % pea protein, by total weight of the pea protein component. Commercially available pea protein components include pea flour (which typically comprises at least about 20 wt %, preferably at least about 25 wt %, typically no more than about 40 wt %, and preferably about 25-30 wt % pea protein), pea protein concentrate (which typically comprises greater than about 40 wt %, typically at least about 50 wt %, and typically less than 75 wt %, more typically less than about 60 wt %, preferably from about 50 to about 55 wt % pea protein) and pea protein isolate (which typically comprises at least 75 wt % pea protein). Preferably, the pea protein component is pea flour or pea protein concentrate. In a particularly preferred embodiment, the pea protein component is pea protein concentrate. The pea protein component may optionally comprise up to about 15 wt % pea fibre, preferably no more than about 5 wt % and typically about 3-5 wt % pea fibre. The balance of the pea protein component typically further comprises starches and other carbohydrates, and moisture.

The animal blood plasma is suitably dried animal blood plasma, as conventionally used in the preparation of reconstituted animal material in pet food products. Preferred animal blood plasma may be porcine or bovine blood plasma or mixtures thereof. Typically, the dried animal blood plasma exhibits a protein content of at least about 70 wt %, preferably at least about 75 wt %, typically no more than about 85 wt %, typically no more than about 80 wt %, by total weight of the dried animal blood plasma.

Preferably the binder comprises animal blood plasma in an amount of at least about 25 wt %, 30 wt %, preferably at least about 40 wt %, preferably at least about 45 wt %, preferably no more than about 60 wt %, preferably no more than about 55 wt %, preferably no more than about 50 wt %, by total weight of the binder.

Preferably the binder comprises said pea fibre component in an amount such that the binder comprises at least about 12 wt %, preferably at least about 15 wt %, preferably at least about 18 wt %, preferably from about 12 wt % to about 22 wt % pea fibre, preferably from about 15 to about 22 wt % pea fibre, preferably from about 18 to about 22 wt % pea fibre, by total weight of the binder. In the preferred embodiments where the pea fibre component comprises from about 45 to about 55 wt % pea fibre (by total weight of the pea fibre component), it is preferred that the binder comprises said pea fibre component in an amount of from about 20 to about 50 wt %, preferably at least about 25 wt %, preferably at least about 30 wt %, preferably at least about 35 wt %, preferably no more than about 45 wt %, by total weight of the binder.

In a particularly preferred embodiment, the binder comprises said pea protein component in an amount such that the binder comprises at least about 5 wt %, preferably at least about 7 wt % by total weight of the binder. Preferably, the binder comprises said pea protein component in an amount such that the binder comprises from about 5 wt % to about 10 wt % pea protein, preferably from about 7 to about 9 wt %, by total weight of the binder. In another preferred embodiment, the binder comprises said pea protein component in an amount such that the binder comprises from about 10 wt % to about 15 wt % pea protein, preferably from about 13 to about 15 wt %, by total weight of the binder.

In the particularly preferred embodiments where the pea protein component comprises from about 50 to about 55 wt % pea protein (by total weight of the pea protein component), it is preferred that the binder comprises said pea protein component in an amount of no more than about 20 wt %, preferably no more than about 15 wt %, preferably no more than about 12 wt %, and preferably at least about 8 wt %, and preferably in the range from about 5 to about 15 wt %, by total weight of the binder. In the preferred embodiments where the pea protein component comprises from about 25 to about 30 wt % pea protein (by total weight of the pea protein component), it is preferred that the binder comprises said pea protein component in an amount of at least about 30 wt %, preferably at least 40 wt %, preferably no more than about 60 wt %, by total weight of the binder.

In a particularly preferred embodiment, the binder comprises:

animal blood plasma in an amount of from about 45 wt % to about 55 wt %, preferably about 50 wt %, by total weight of the binder;

a pea fibre component in an amount of from about 35 wt % to about 45 wt %, preferably about 40 wt %, by total weight of the binder, wherein said pea fibre component comprises from about 45 to about 55 wt % pea fibre by total weight of the pea fibre component; and

a pea protein component in an amount of from about 5 wt % to about 15 wt %, preferably about 10 wt %, by total weight of the binder, where the pea protein component comprises from about 50 to about 55 wt % pea protein by total weight of the pea protein component.

In a further preferred embodiment, the binder comprises:

animal blood plasma in an amount of from about 20 wt % to about 30 wt %, preferably about 25 wt %, by total weight of the binder;

a pea fibre component in an amount of from about 20 wt % to about 30 wt %, preferably about 25 wt %, by total weight of the binder, wherein said pea fibre component comprises from about 45 to about 55 wt % pea fibre by total weight of the pea fibre component; and

a pea protein component in an amount of from about 45 wt % to about 55 wt %, preferably about 50 wt %, by total weight of the binder, where the pea protein component comprises from about 25 to about 30 wt % pea protein by total weight of the pea protein component.

The inventors have unexpectedly found that the binders defined herein are heat-settable. In other words, the binder creates a matrix with meat or animal protein when heated above about 80° C. The matrix is sufficiently strong to create a strong and stable chunk, particularly such that the matrix is able to be able to withstand the retort/sterilisation process described hereinbelow.

The reconstituted animal material preferably comprises from about 0.5 to about 10 wt %, preferably from about 0.5 to about 8 wt %, preferably from about 0.5 to about 5 wt %, preferably at least about 2 wt %, preferably at least about 3 wt %, preferably from about 3 to about 5%, preferably at least about 4 wt % of the binder, by total weight of the reconstituted animal material.

The reconstituted animal material comprises animal protein. As used herein, the term “animal protein” refers to proteins that originate from vertebrates, such as mammals, fowl and fish. Animal protein may originate, for example, from muscle meat, organs, tendons or bone.

The animal protein in the reconstituted animal material is typically derived from ground animal material, said ground animal material preferably being selected from meat, animal by-products and combinations thereof. The ground animal material may contain at least 50 wt %, or at least 70 wt % or at least 85 wt % of animal by-product. Animal by-products are the entire bodies or parts of bodies of animals or products of animal origin not intended for human consumption; such by-products are conventional in the art for the manufacture of ground animal material suitable for use in pet food products.

Preferably, the reconstituted animal material contains, or is derived from a composition comprising:
(i) binder in an amount from about 0.5 to about 10 wt % by total weight of the reconstituted animal material, as described above;
(ii) ground animal material in an amount of from about 50 to about 99 wt %, preferably from about 60 to about 99 wt %, preferably from about 65 to about 99 wt %, %, and preferably no more than about 95 wt % or no more than about 90 wt % or no more than about 85 wt %, by total weight of the reconstituted animal material.

The reconstituted animal material, or the composition from which it is derived, may further comprise added water.

The reconstituted animal material may further contain additional ingredients conventionally used in the manufacture of reconstituted meat and wet pet food products, such as fat(s), antioxidant(s), carbohydrate source(s), fibre source(s), additional source(s) of protein (including vegetable protein), seasoning, colorant(s), flavouring(s), mineral(s), preservative(s), vitamin(s), emulsifier(s), farinaceous material(s) and combinations thereof.

In particular, because the protein content of the mixed binder disclosed herein is normally less than the protein content of pure animal blood plasma, it is preferred that the reconstituted animal material further contains an additional source of protein, which may be added to the ground animal material, or to the mixture of ground animal material and binder. Suitable additional sources of protein include poultry meal or greaves meal, well known in the art. Suitably, such additional protein may be added in an amount of up to about 5 wt %, preferably up to about 2 wt %, and typically about 1 wt %, of the total weight of the reconstituted animal material.

The reconstituted animal material may be prepared by an extrusion process at elevated temperature, according to conventional techniques known in the art.

Preferably, the reconstituted animal material is prepared by a process comprising the steps of:
(a) providing ground animal material (which is suitably prepared by grinding pieces of animal material to prepare ground animal material, said animal material being selected from meat, animal by-products and combinations thereof);
(b) mixing the ground animal material with the heat-settable binder, and optionally additional ingredients, for instance the additional ingredients conventionally used in the manufacture of reconstituted meat and wet pet food products described hereinabove, to prepare a slurry;
(c) subjecting the slurry to conditions of shear to produce an emulsion;
(d) forming a layer of emulsion;
(e) heating the layer of emulsion to an internal temperature of at least 70° C. (preferably at least about 80° C.); and
(f) cutting or shredding the layer into discrete pieces of reconstituted animal material.

The ingredients may be mixed using any suitable equipment conventional in the art, for instance a heated extruder or a jacketed paddle mixer, optionally combining the ingredients with water.

In the process described above, the slurry preferably comprises from about 50 to about 99 wt % (preferably from about 60 to about 99 wt %, preferably from about 65 to about 99 wt %, %, and preferably no more than about 95 wt % or no more than about 90 wt % or no more than about 85 wt %) of the ground animal material.

The emulsification of the slurry may be performed in any conventional equipment, for instance a bowl chopper, or meat grinders, including rotating knives and die-plate combinations comprising holes of a defined diameter (for instance from about 0.5 mm to about 10 mm) through which the material passes. Optionally, the resulting material may then be transferred to a mixer where water, dry ingredients (e.g. protein powder of vegetable origin) and liquid ingredients may be added.

The layer of emulsion formed in the process may take the form of, for instance, a sheet, a slab, a ribbon or rope.

In order to activate the heat-settable binder, the emulsion is suitably heated to an internal temperature of at least 70° C., preferably at least 75° C., preferably at least 80° C., and typically no more than about 105° C. The duration of heating is at least 30 seconds, preferably from about 1 to about 60 minutes. The heating of the layer of emulsion is suitably conducted in a steam tunnel.

The layer of emulsion is suitably heated from below by applying steam to the underside of a continuous belt carrying said layer and/or from above by bringing steam into direct contact with the layer of emulsion. Preferably, the emulsion is cooked in a steam tunnel, typically comprising a conveyor system (such as a conveyor belt), which blanches or cooks the emulsion with saturated or super-heated steam injected from above and/or below, thereby exposing the emulsion to a continual and even application of steam to ensure it is cooked thoroughly and set. The emulsion may be in the form of individual chunks during the heating step, but typically cutting into chunks is performed after the heating step.

As used herein, the term “emulsion” refers to a thick mixture of water and other substances derived from raw materials, such as meat or meat by-products. These “emulsions” are dispersions of fat particles and air bubbles in a complex phase composed of water, solubilized meat protein, cellular components and other ingredients. The emulsions may also be referred to as a meat “batter” or a meat “slurry”. Such terms are well understood in the art and are used interchangeably. Typically, the emulsions comprise a continuous phase which is an aqueous medium comprising soluble proteins, soluble muscle constituents, segments of muscle fibers, connective tissue fibers, bones etc., and optionally materials of plant origin materials such as proteins and/or starches and/or fibres and/or minerals, as well as further additives conventional in the art.

Other methods to form the reconstituted animal material include the high moisture extrusion techniques described in WO-00/69276-A. Another suitable process for making the reconstituted animal material is described in U.S. Pat. No. 4,247,562. In general terms, the heated extruder is used to combine ingredients, typically also with water. The mixture is plasticised and heated to form a hot, viscous and at least partly molten mass. The extruder mixes, heats, coagulates, expands and shears the mixture into a meat-like mass which is then extruded and formed into shapes as desired.

A particular advantage of the present invention is the ability to use standard processing and equipment to form the reconstituted animal material.

The total protein content of the reconstituted animal material is preferably in an amount in the range of from about 5 to about 40 wt %, preferably at least about 10 wt %, preferably at least about 15 wt %, and typically no more than about 36 wt %, and preferably from about 25 wt % to about 36 wt %. The protein may comprise animal protein(s), vegetable protein(s) or any combination thereof. The protein fraction of the reconstituted animal material preferably contains at least 50 wt % of animal protein, preferably at least about 60 wt %, preferably at least about 70 wt %, preferably at least about 80 wt %, preferably at least about 90% of animal protein, by total weight of the protein fraction of the reconstituted animal material. Animal proteins include any protein of animal origin (including vertebrate and invertebrate proteins), e.g. proteins derived from mammals, fowl, fish and insects. Examples of suitable animal proteins include those derived from chicken, turkey, beef, lamb, pork, venison, buffalo, duck, kangaroo, shell fish, crustaceans, salmon, tuna, whitefish and the like. They may suitably be derived from muscle meat, organs, tendons, bone etc. Further suitable animal proteins include milk or egg derived proteins. Suitable vegetable proteins include proteins derived from wheat, maize, pea, lupine, potato and the like, for example wheat gluten. The proteins may be in any suitable form, including but not limited to, isolated or partially isolated, concentrated or ground.

The fat content of the reconstituted animal material is preferably less than about 15 wt %, preferably no more than about 13 wt %, preferably no more than about 12 wt %, preferably no more than about 10 wt %, preferably no more than about 8 wt %, preferably at least about 2 wt %, preferably at least about 4 wt %. The term “fat” as used herein refers to esters of fatty acids such as triglycerides, diglycerides, monoglycerides and phospholipids. The fat preferably contains at least 50 wt %, more preferably at least 70 wt % of triglycerides. The fat may suitably contain animal fat, vegetable oil, marine oil and combinations thereof. Typically, the fat contains at least 10 wt %, more preferably at least 30 wt % and most preferably at least 50 wt % of an animal fat. The animal fat preferably originates from an animal selected from cattle, pigs, sheep, goat, poultry, fish and combinations thereof.

The water content of the reconstituted animal material is typically up to about 75 wt %, or up to about 65 wt %, and typically at least about 20 wt % or at least about 30 wt % or at least about 40 wt % or at least about 50 wt %, and preferably in the range of from about 50 to about 55 wt %, by total weight of the reconstituted animal material.

The fibre and carbohydrate content of the reconstituted animal material is typically up to about 20 wt %, by total weight of the reconstituted animal material. Preferably, the reconstituted animal material comprises no more than about 10 wt % fibre, preferably no more than about 5 wt %, preferably no more than about 2 wt %, typically no more than about 1 wt %, and preferably at least about 0.5 wt %, by total weight of the reconstituted animal material.

The reconstituted animal material typically exhibits a density of from about 0.8 to about 1.2 g/ml.

The size of the reconstituted animal material will vary and depends on the animal that is to consume the pet food and/or the format of the pet food. The longest dimension of the reconstituted animal material is typically from about 5 mm to about 200 mm, preferably at least about 10 mm, preferably no more than about 150 mm. Where the reconstituted animal material is a chunk suitable for a chunk-in-sauce product, as described hereinbelow, the longest dimension is preferably no more than about 50 mm, more preferably no more than about 40 mm, more preferably no more than about 30 mm, and in a preferred embodiment from about 5 mm to 25 mm, preferably from about 13 to about 20 mm.

The reconstituted animal material may also be referred to as a “meat analogue”.

The term “pet food” as used herein refers to a food composition designed for ingestion by a pet. The wet pet food provided herein is preferably a nutritionally balanced food product to provide a pet with all the essential nutrients it needs in the appropriate quantities.

The pet food may be a pet food providing health and/or nutrition benefits to the pet, e.g. weight management pet foods, satiety pet foods and/or pet foods capable of improving renal function in the pet.

The wet pet food product and the components used therein are selected for consumption by a pet and are not intended for consumption by humans. The term “pet” as used herein preferably refers to a domestic animal, preferably a companion animal, particularly cats or dogs, and in one embodiment cats.

The wet pet food may be a loaf (or pate) product. As noted above, such products are normally in the form of a single piece of reconstituted animal material packaged in a container, such as a can, a pouch or a tray. Typically, these shaped pieces of reconstituted animal material have a piece volume of from about 20 to about 2,000 cm³, more preferably from about 40 to about 1,500 cm³, for instance from about 500 to about 1200 cm³. After packaging and sealing, the aforementioned product is preferably sterilized within the package, e.g. by retort sterilization.

Alternatively, the wet pet food is a chunk-in-sauce product, as described herein above. The term “sauce” as used herein encompasses gravies, jellies and mousses, and preferably refers to a composition in the form of a fluid, a paste, a gel or a mousse. The sauce comprises a liquid carrier, such as water, fats or oils. Preferably the composition is an aqueous composition. A chunks-in-sauce product is prepared by combining the pieces of reconstituted animal material with a sauce, packaging the combination, sealing in the package and sterilizing the package, e.g. by retort sterilization. The pieces of reconstituted animal material may be added to the packaging while the sauce is poured over the pieces, for instance a heated sauce which allows the pieces to warm up and trapped gases to be expelled prior to sealing the packaging. Alternatively, ingredients are added to the reconstituted animal material and packaged, where the ingredients, in the usual sterilisation process, result in the formation in the package of the sauce mixed with the reconstituted animal material.

Sealing of the packaging may be and preferably is conducted using vacuum-sealing.

Retort sterilization is preferably conducted at a retorting temperature in the range from about 115° C. to about 130° C., preferably for approximately 20 to 120 minutes, in order to produce a commercially sterile product.

The packaging may be a can (or tin) or jar (e.g. glass) or otherwise a plastic, metal, foil pouch, or flexifoil.

The wet pet food product may comprise up to 100 wt % of the reconstituted animal material, and preferably at least about 5 wt % of the reconstituted animal material, by total weight of the wet pet food product. In other words, the wet pet food product may comprise, consist essentially or consist of the reconstituted animal material. A loaf product suitably consists essentially or consists of the reconstituted animal material. A chunks-in-sauce product preferably comprises a ratio of reconstituted animal material: sauce of from about 20:80 to about 90:10, preferably at least about 30:70, preferably at least about 40:60, preferably at least about 50:50, preferably at least about 60:40.

The sauce component of the wet pet food product may be any suitable sauce conventional in the art of wet pet food, and typically exhibits a water content of at least about 80 wt %, typically at least about 90 wt %, typically no more than about 98 wt %, by total weight of the sauce. The sauce typically comprises a thickening agent which is used to control its consistency. Thickeners or gelling agents that may be used to prepare the sauce include carrageenan, xanthan, guar gum, cassia gum, starch, gelatine and combinations thereof. The sauce is typically a coating which surrounds the reconstituted animal material.

The sauce may contain additional ingredients conventionally used in the manufacture of wet pet food products, such as fat, antioxidants, carbohydrates, seasoning, colorants, flavouring, minerals, preservatives, vitamins, emulsifiers, farinaceous materials and combinations thereof. The sauce preferably comprises one or more flavouring agents.

Flavourings impart particular taste or smell and may be derived from natural ingredients or artificially created. Flavourings may include one or more products of the Maillard reaction. Flavouring agents such as beef flavour and meat flavour can be used in amounts sufficient to impart the desired flavour.

The total protein content of the chunk-in-sauce wet pet food product is preferably in the range of from about 5 to about 20 wt %, preferably from about 5 to about 10 wt %, by total weight of the product.

The total fat content of the chunk-in-sauce wet pet food product is preferably no more than about 15 wt %, preferably no more than about 10 wt %, preferably no more than about 7 wt %, preferably at least about 2 wt %, by total weight of the product.

The total fibre content of the chunk-in-sauce wet pet food product is preferably no more than about 5 wt %, preferably no more than about 2 wt %, preferably no more than about 1 wt %, preferably at least about 0.1 wt %, by total weight of the product.

The water content of the chunk-in-sauce wet pet food product is typically at least about 70 wt %, preferably at least about 75 wt %, and preferably at least about 80 wt %, preferably no more than about 95 wt %, preferably no more than about 90 wt %, by total weight of the product.

Preferably, the amount of fines (i.e. solid material having a longest dimension of no more than 3 mm) in the chunk-in-sauce wet pet food product is no more than about 10 wt %, preferably no more than about 8 wt %, preferably no more than about 5 wt %, preferably no more than about 3 wt %, by total weight of the wet pet food product.

According to a further aspect of the invention, there is provided a dry or semi-moist pet food product, i.e. a product exhibiting less than 15 wt % moisture or from 15 to 50 wt % respectively, comprising or consisting essentially or consisting of the reconstituted animal material described herein. The reconstituted animal material may also be incorporated into pet food products generally, including supplements, snacks and treats, such as a dry kibble product.

According to a further aspect of the invention, there is provided a process for preparing the reconstituted animal material described hereinabove, wherein said process comprises preparing said reconstituted animal material by an extrusion process at elevated temperature.

According to a further aspect of the invention, there is provided a process for preparing the reconstituted animal material described herein, said process comprising the steps of:
(a) mixing ground animal material with the heat-settable binder described herein;
(b) preferably, preparing a slurry from said mixture and subjecting the slurry to conditions of shear to produce an emulsion of said mixture;
(c) heating the mixture to an internal temperature of at least 70° C. (preferably at least about 80° C.); and
(d) forming discrete pieces of reconstituted animal material.

According to a further aspect of the invention, there is provided a process for preparing a wet pet food product comprising the reconstituted animal material described herein, said process comprising the steps of:
(a) mixing ground animal material with the heat-settable binder described herein;
(b) preferably, preparing a slurry from said mixture and subjecting the slurry to conditions of shear to produce an emulsion of said mixture;
(c) heating the mixture to an internal temperature of at least 70° C. (preferably at least about 80° C.);
(d) forming discrete pieces of reconstituted animal material;
(e) optionally combining said reconstituted animal material with a sauce;
(f) inserting said reconstituted animal material and optional sauce into packaging; and
(g) sealing and sterilizing the package to provide a packaged wet pet food product.

The present invention will now be described with reference to the following non-limiting examples.

### EXAMPLES

### Reference Example 1 and Example 1

Wet cat food products comprising reconstituted animal material was prepared by mixing ground animal material with heat-settable binder. In each case, the reconstituted animal material comprised 4 wt % of the binder, by total weight of the reconstituted animal material. The binder in Reference Example 1 was conventional dried porcine blood plasma. The binder in Example 1 consisted of a mixture of dried porcine blood plasma, a pea fibre component (containing 50 wt % of pea fibre and 7 wt % pea protein) and a pea protein component (a pea protein concentrate containing 50 wt % of pea protein and about 4 wt % pea fibre) in a ratio of 50:40:10 by weight. The ground animal material for Example 1 was supplemented with 1 wt % of poultry meal in order to compensate for the relatively lower protein content of the new binder (compared to pure porcine blood plasma), and maintain the protein content of the final product at a level similar to that of Reference Example 1. In each case, a slurry was prepared from the mixture of ground animal material and heat-settable binder and the slurry subjected to conditions of shear to produce an emulsion. The emulsion was heated to at least 80° C. and then cut to generate discrete pieces of reconstituted animal material. The reconstituted animal material was then combined with a conventional water-based sauce to generate a chunks-in-sauce wet cat food.

The properties of the products are given in Table 1 below. Example 1 had the same visual appearance as Reference Example 1.

TABLE 1

| | Reference Example 1 | Example 1 |
|---|---|---|
| Protein (wt %) | 7.8 | 7.3 |
| Moisture (wt %) | 82.94 | 83.50 |
| Fat (wt %) | 5.0 | 4.6 |
| Fibre (wt %) | 0.3 | 0.4 |

The amount of fines in the freshly made product was measured by putting the chunks under stress in a hammer mill, followed by sieving using rotating sieves with varying pore sizes. The sieved products are collected and weighed and then a ratio of the weights are calculated against the original product used for the stress test. Thus, 5 kg of chunks are first pre-sieved to remove any residual fines remaining from production. The chunks are fed into the hammer mill, and the products collected and weighed. The “lost” product, usually sticking to the hammer mill, were counted as fines. The collected product is then fed into co-rotating concentric sieves, which partition the collected product into three fractions: large (unbroken), medium (broken but still large enough not to pass through a 3 mm screen) and fines (small enough to pass through a 3 mm screen). The weight of each fraction is recorded. The difference between the weight of the collected product and the sum of the weights of all three fractions is counted as fines sticking to the sieves and, together with the “lost” product at the hammer mill and the fraction passing through the 3 mm sieves, a total amount of fines is calculated.

Thus, the size distribution may be described in terms of:

(i) the amount of fines 3 mm);
(ii) the amount of medium-sized chunks (for cat food, a longest dimension of from 5 mm to no more than 7 mm); and
(iii) the amount of large-sized chunks (for cat food, a longest dimension of greater than 7 mm),
all calculated as a % wt of the total weight of the chunks.

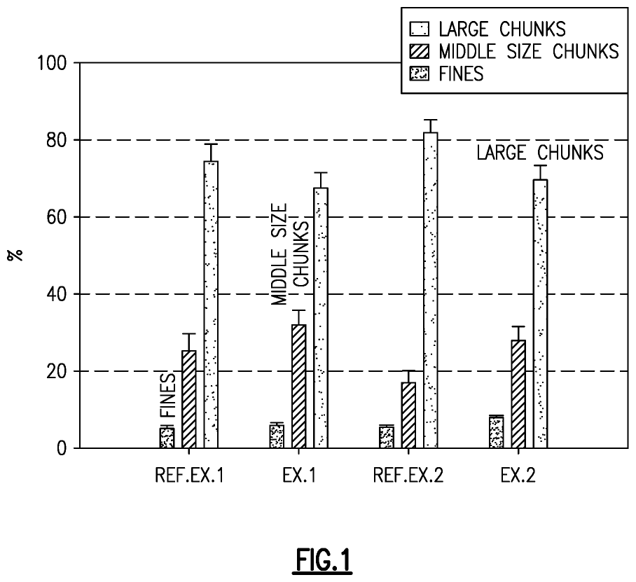

The size distribution is presented in FIG. 1. The amounts of fines, medium chunks and large chunks for Example 1 were the same as those for Reference Example 1, within experimental error.

The mean hardness of the solid pieces of reconstituted animal material was determined by texture profile analysis (TPA) using a double compression method. The chunk is first compressed to 50% of its original chunk height, the pressure released, and the chunk then compressed a second time to 50% of its chunk height. The mean hardness of a freshly made chunk, and the mean hardness of the finished product was tested. The mean hardness of the chunks of Example 1 was within acceptable quality control limits for, or equivalent to, the existing commercial product, as represented by Reference Example 1, in respect of both fresh chunk hardness and finished product hardness.

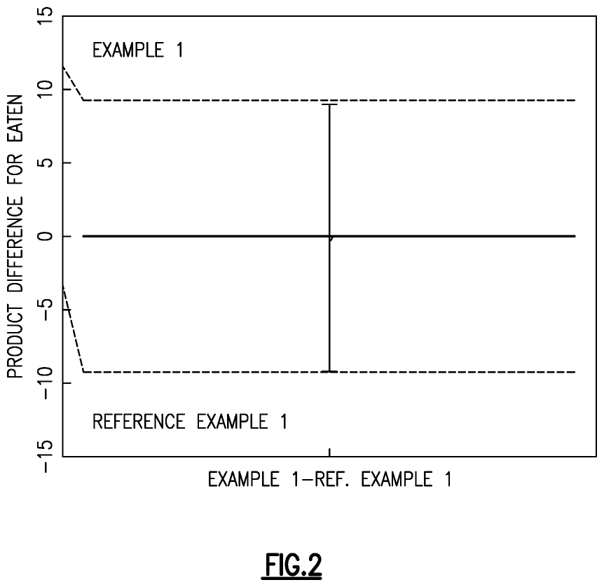

The palatability of Example 1 and Reference Example 1 was compared in a feeding trial by measuring the amount of the product eaten by cats. The results are shown in FIG. 2 and demonstrate that Example 1 is equivalent to Reference Example 1 in the non-inferiority test.

### Reference Example 2 and Example 2

Wet dog foods were prepared in a manner similar to that described above, using 1 wt % poultry meal in the ground animal material for Example 2, and the properties of the products are given in Table 2 below. Example 2 had the same visual appearance as Reference Example 2.

TABLE 2

| | Reference Example 2 | Example 2 |
|---|---|---|
| Protein (wt %) | 8.6 | 8.4 |
| Moisture (wt %) | 83.62 | 83.37 |
| Fat (wt %) | 5.1 | 5.2 |
| Fibre (wt %) | 0.4 | 0.6 |

The size distribution of the reconstituted animal material is presented in FIG. 1. The amounts of fines, medium chunks and large chunks for Example 2 differed slightly from those for Reference Example 2, but within the acceptable quality control limits for the commercial product.

The mean hardness of the chunks of Example 2 was within acceptable quality control limits for the existing commercial product, as represented by Reference Example 2, in respect of both fresh chunk hardness and finished product hardness.

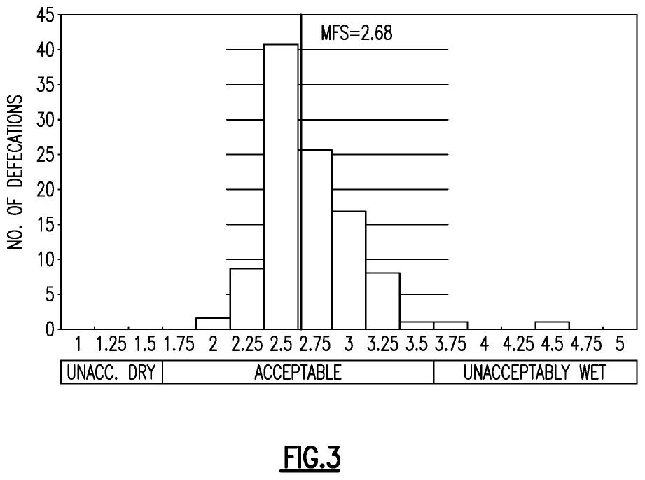

The faeces of eight dogs (mixed sizes) fed with the wet food product of Example 2 were examined and analysed for Dry Matter Digestibility, Wet Faeces Output, Mean Faeces Score and Unwanted Faeces. The results are presented in Table 3 below and FIG. 3 (Mean Faeces Score).

TABLE 3

| | Quality | |
|---|---|---|
| Property | control ranges | Example 2 |
| Dry matter Digestibility (%) | Good: ≥80 | 82.1 |
| | Average: ≥77.5 | |
| | Poor: <77.5 | |
| Wet Faeces Output (WFO) (g/1000 kcal) | Good: ≤185 | 152.7 |
| | Average: ≤215 | |
| | Poor: >215 | |
| Mean Faeces Score (MFS) | Good: <2.7 | 2.68 |
| | Average: ≤2.8 | |
| | Poor: >2.8 | |
| Unwanted Faeces (UF) (%) | Good: <3 | 1.8 |
| | Average: ≤6 | |
| | Poor: >6 | |

The results demonstrate that both wet cat food and wet dog food prepared from the binder of the present invention maintain the excellent characteristics exhibited by the existing products in which the binder consisted of dried animal blood plasma. In particular, the amounts of fines in the product demonstrate that the chunks are sufficiently hard and stable to resist breakage.

### Example 3

A wet cat food product was prepared in similar manner to Example 1 except firstly that the pea protein component was a pea flour containing 25 wt % of pea protein and 14.5 wt % of pea fibre, and secondly that the binder consisted of a mixture of dried porcine blood plasma, the pea fibre component and the pea protein component in a ratio of 25:25:50. The product quality was good in terms of texture, hardness and palatability and within acceptable quality control limits.

### Comparative Examples 1 to 4

Wet cat food products were prepared in a similar manner to Example, using varying amounts of dried porcine blood plasma, pea fibre component and the pea protein component, as shown in Table 4 below. The products were inferior in terms of chunk hardness.

TABLE 4

| | | | | TOTAL | TOTAL | |
|---|---|---|---|---|---|---|
| | BLOOD | | PEA | PEA | PEA | |
| | PLASMA | PEA FIBRE | PROTEIN | FIBRE | PROTEIN | |
| | IN | COMPONENT | COMPONENT | IN | IN | |
| | BINDER | (and amounts | (and amounts | BINDER | BINDER | |
| | (wt %) | in binder) | in binder) | (wt %) | (wt %) | Performance |
| Ref. Ex. 1 | 100 | — | — | — | — | Existing product |
| Example 1 | 50 | Fibre (40 wt %) | PPC (10 wt %) | 20.4 | 7.8 | Equivalent to |
| | | | | | | existing product |
| | | | | | | in terms of |
| | | | | | | texture, fines & |
| | | | | | | palatability |
| Example 3 | 25 | Fibre (25 wt %) | Flour (50 wt %) | 19.75 | 14.25 | Product quality |
| | | | | | | good; within |
| | | | | | | acceptable |
| | | | | | | quality control |
| | | | | | | limits |
| Comp. Ex. 1 | 0 | — | Flour (50 wt %) + | 9.25 | 37.5 | Inferior to |
| | | | PPC (50 wt %) | | | existing product |
| Comp. Ex. 2 | 0 | — | PPC (100 wt | 4 | 50 | Inferior to |
| | | | %) | | | existing product |
| Comp. Ex. 3 | 25 | — | Flour (50 wt %) + | 8.25 | 25 | Inferior to |
| | | | PPC (25 wt %) | | | existing product |
| Comp. Ex. 4 | 10 | Fibre (40 wt %) | Flour (50 wt %) | 27.25 | 15.3 | Inferior to |
| | | | | | | existing product |

PPC = Pea Protein Concentrate comprising 50 wt % pea protein, and 4 wt % pea fibre
Flour = Pea Flour comprising 25 wt % pea protein and 14.5 wt % pea fibre
Fibre = Pea Fibre component comprising 50 wt % pea fibre and 7 wt % pea protein

1. A reconstituted animal material comprising animal protein and a binder, wherein the binder comprises:
(i) animal blood plasma in an amount of from about 20 to about 65 wt % by total weight of the binder;
(ii) a pea fibre component comprising pea fibre in an amount from about 10 wt % to about 25 wt % by total weight of the binder; and
(iii) a pea protein component comprising pea protein in an amount from about 2 wt % to about 15 wt % by total weight of the binder,
wherein components (ii) and (iii) are different and are derived from pea vegetable matter.

2. The reconstituted animal material of claim 1, wherein the binder comprises animal blood plasma in an amount of from about 45 wt % to about 55 wt %, by total weight of the binder.

3. The reconstituted animal material of claim 1, wherein the animal blood plasma is dried animal blood plasma, preferably porcine and/or bovine blood plasma.

4. The reconstituted animal material of claim 1, wherein the pea fibre component comprises from about 45 wt % to about 60 wt % pea fibre, by total weight of the pea fibre component.

5. The reconstituted animal material of claim 1, wherein the pea fibre component comprises from about 45 to about 55 wt % pea fibre by total weight of the pea fibre component, and the binder comprises the pea fibre component in an amount of from about 20 to about 50 wt %, by total weight of the binder.

6. The reconstituted animal material of claim 1, wherein the binder comprises the pea fibre component in an amount such that the binder comprises from about 12 wt % to about 22 wt %, preferably from about 15 to about 22 wt %, preferably from about 18 to about 22 wt % pea fibre, by total weight of the binder.

7. The reconstituted animal material of claim 1,
wherein the pea protein component comprises at least about 20 wt % and/or less than about 75 wt % pea protein, by total weight of the pea protein component, and/or
wherein the pea protein component is selected from the group consisting of pea flour and pea protein concentrate, wherein the pea flour comprises from about 20 wt % to about 40 wt % pea protein and the pea protein concentrate comprises from about 40 wt % to about 75 wt % pea protein.

8. The reconstituted animal material of claim 1,
wherein the pea protein component comprises from about 50 to about 55 wt % pea protein by total weight of the pea protein component, and
wherein the binder comprises the pea protein component in an amount of no more than about 20 wt %, preferably no more than about 15 wt %, and preferably in the range from about 5 to about 15 wt %, by total weight of the binder.

9. The reconstituted animal material of claim 1, wherein the binder comprises the pea protein component in an amount such that the binder comprises from about 5 wt % to about 10 wt % pea protein, by total weight of the binder.

10. The reconstituted animal material of claim 1, wherein the pea protein component comprises from about 25 to about 30 wt % pea protein by total weight of the pea protein component, and the binder comprises the pea protein component in an amount of at least about 30 wt %, preferably at least 40 wt %, by total weight of the binder.

11. The reconstituted animal material of claim 1, wherein the binder comprises the pea protein component in an amount such that the binder comprises from about 10 wt % to about 15 wt % pea protein, by total weight of the binder.

12. The reconstituted animal material of claim 1, wherein the binder comprises:
animal blood plasma in an amount of from about 45 wt % to about 55 wt %, preferably about 50 wt %, by total weight of the binder;
a pea fibre component in an amount of from about 35 wt % to about 45 wt %, preferably about 40 wt %, by total weight of the binder, wherein the pea fibre component comprises from about 45 to about 55 wt % pea fibre by total weight of the pea fibre component; and
a pea protein component in an amount of from about 5 wt % to about 15 wt %, preferably about 10 wt %, by total weight of the binder, where the pea protein component comprises from about 50 to about 55 wt % pea protein by total weight of the pea protein component.

13. The reconstituted animal material of claim 1, wherein the binder comprises
animal blood plasma in an amount of from about 20 wt % to about 30 wt %, preferably about 25 wt %, by total weight of the binder;
a pea fibre component in an amount of from about 20 wt % to about 30 wt %, preferably about 25 wt %, by total weight of the binder, wherein the pea fibre component comprises from about 45 to about 55 wt % pea fibre by total weight of the pea fibre component; and
a pea protein component in an amount of from about 45 wt % to about 55 wt %, preferably about 50 wt %, by total weight of the binder, where the pea protein component comprises from about 25 to about 30 wt % pea protein by total weight of the pea protein component.

14. The reconstituted animal material of claim 1, wherein the binder is heat-settable.

15. The reconstituted animal material of claim 1, wherein the reconstituted animal material comprises from about 0.5 to about 10 wt %, preferably from about 0.5 to about 5 wt %, by total weight of the reconstituted animal material.

16. The reconstituted animal material of claim 1, wherein the reconstituted animal material contains, or is derived from, a composition comprising:
(i) binder in an amount from about 0.5 to about 10 wt % by total weight of the reconstituted animal material; and
(ii) ground animal material in an amount of from about 50 to about 99 wt %, by total weight of the reconstituted animal material.

17. The reconstituted animal material of claim 1, wherein the reconstituted animal material further comprises additional ingredients selected from the group consisting of fat(s), antioxidant(s), carbohydrate source(s), fibre source(s), additional source(s) of protein, seasoning, colorant(s), flavouring(s), mineral(s), preservative(s), vitamin(s), emulsifier(s), farinaceous material(s) and combinations thereof.

18. The reconstituted animal material according to claim 1, wherein a total protein content of the reconstituted animal material is in a range of from about 5 to about 40 wt %, preferably from about 25 wt % to about 36 wt %, by total weight of the reconstituted animal material, preferably wherein the protein content of the reconstituted animal material comprises at least 50 wt % of animal protein by total weight of the protein content of the reconstituted animal material.

19. The reconstituted animal material according to claim 1, wherein the fat content of the reconstituted animal material is less than about 15 wt % and preferably from about 4 wt % to about 13 wt %, preferably wherein the fat content comprises at least 50 wt % of triglycerides by total weight of the fat content.

20. The reconstituted animal material according to claim 1, wherein the water content of the reconstituted animal material is up to about 75 wt %, and preferably from about 50 to about 55 wt %, by total weight of the reconstituted animal material.

21. The reconstituted animal material according to claim 1, wherein the reconstituted animal material exhibits a density of from about 0.8 to about 1.2 g/ml.

22. The reconstituted animal material according to claim 1, wherein a longest dimension of the reconstituted animal material is from about 5 mm to about 150 mm.

23. A pet food product comprising the reconstituted animal material of claim 1.

24. The pet food product according to claim 23, wherein the pet food product is a wet pet food product.

25. The pet food product according to claim 24, which is a nutritionally balanced food product.

26. The pet food product according to claim 24, which is a loaf product in the form of a single piece of reconstituted animal material, preferably having a piece volume of from about 20 to about 2,000 cm³.

27. The pet food product according to claim 24, which is a chunk-in-sauce product, preferably wherein the ratio of reconstituted animal material:sauce is from about 20:80 to about 90:10.

28. The wet pet food product according to claim 27, wherein the sauce exhibits a water content of at least about 80 wt % by total weight of the sauce, preferably wherein the sauce comprises a thickening agent selected from the group consisting of carrageenan, xanthan, guar gum, cassia gum, starch, gelatine and combinations thereof.

29. The wet pet food product according to claim 27, wherein the wet pet food product comprises fines in an amount of no more than about 3 wt %.

30. The pet food product according to claim 24, wherein the wet pet food product comprises from about 5 wt % to about 100 wt % of the reconstituted animal material, by total weight of the wet pet food product.

31. The pet food product according to claim 23, which is a dry or semi-moist pet food product.

32. (canceled)

33. A process for preparation of reconstituted animal material comprising animal protein and a binder, the process comprising the steps of:
(a) mixing a ground animal material with a heat-settable binder comprising:
(i) animal blood plasma in an amount of from about 20 to about 65 wt % by total weight of the binder;
(ii) a pea fibre component comprising pea fibre in an amount from about 10 wt % to about 25 wt % by total weight of the binder; and
(iii) a pea protein component comprising pea protein in an amount from about 2 wt % to about 15 wt % by total weight of the binder;
wherein components (ii) and (iii) are different and are derived from pea vegetable matter;
(b) preferably, preparing a slurry from the mixture and subjecting the slurry to conditions of shear to produce an emulsion of the mixture;
(c) heating the mixture to an internal temperature of at least 70° C., preferably at least about 80° C., preferably wherein the duration of heating is at least 30 seconds; and
(d) forming discrete pieces of reconstituted animal material.

34. A process for preparation of a wet pet food product comprising reconstituted animal material, the process comprising the steps of:
(a) mixing a ground animal material with a heat-settable binder comprising:
(i) animal blood plasma in an amount of from about 20 to about 65 wt % by total weight of the binder;
(ii) a pea fibre component comprising pea fibre in an amount from about 10 wt % to about 25 wt % by total weight of the binder; and
(iii) a pea protein component comprising pea protein in an amount from about 2 wt % to about 15 wt % by total weight of the binder;
wherein components (ii) and (iii) are different and are derived from pea vegetable matter;
(b) preferably, preparing a slurry from the mixture and subjecting the slurry to conditions of shear to produce an emulsion of the mixture;
(c) heating the mixture to an internal temperature of at least 70° C., preferably at least about 80° C., preferably wherein the duration of heating is at least 30 seconds;
(d) forming discrete pieces of reconstituted animal material;
(e) optionally combining the reconstituted animal material with a sauce;
(f) inserting the reconstituted animal material and optional sauce into a package; and
(g) sealing and sterilizing the package to provide a packaged wet pet food product.

35. The process according to claim 33, wherein the slurry comprises a ground animal material in an amount of from about 50 to about 99 wt % by weight of the slurry.

36. The process according to claim 33, wherein the heating of the mixture is conducted by heating from below by applying steam to an underside of a continuous belt carrying the mixture and/or from above by bringing steam into direct contact with the mixture.

37. The process for preparation of a wet pet food product according to claim 34, wherein the pet food is a wet pet food of claim 25.
